(19) United States
(12) Patent Application Publication
(10) Pub. No.: US 2022/0032265 A1
(43) Pub. Date: Feb. 3, 2022

(54) GAS STORAGE MATERIAL

(71) Applicants: L'Air Liquide, Société Anonyme pour l'Etude et l'Exploitation des Procédés Georges Claude, Paris (FR); Kyoto University, Kyoto-shi (JP); National University Corporation Tokai National Higher Education and Research System, Nagoya-shi (JP)

(72) Inventors: Bruno FONTAINE, Tsukuba City (JP); Patrick GINET, Tsukuba City (JP); Akihiro HORI, Nagoya City (JP); Nobuhiko HOSONO, Kyoto City (JP); Shinpei KUSAKA, Kyoto City (JP); Susumu KITAGAWA, Kyoto City (JP); Christophe LAVENN, Tsukuba City (JP); Yunsheng MA, Nagoya-shi (JP); Ryotaro MATSUDA, Nagoya City (JP); Mickaele BONNEAU, Tsukuba City (JP)

(21) Appl. No.: 17/277,434

(22) PCT Filed: Sep. 5, 2019
(86) PCT No.: PCT/EP2019/073684

§ 371 Date: Mar. 18, 2021

(30) Foreign Application Priority Data
Sep. 20, 2018 (JP) 2018-175922

(51) Int. Cl. B01J 20/22; B01J 20/28; F17C 11/00

(52) U.S. Cl. CPC B01J 20/226; B01J 20/28011; F17C 11/002; B01J 20/28014

(57) ABSTRACT

To provide a gas storage material and gas separation system capable of regulating the storage pressure and release pressure of a gas. A gas storage material which has two cubic lattice-shaped organometallic complexes, wherein the two organometallic complexes form an interpenetrating structure in which one apex portion of a unit cell of one of the organometallic complexes is positioned in a space inside one unit cell of the other organometallic complex.

### CROSS REFERENCE TO RELATED APPLICATIONS

This application is a 371 of International Application No. PCT/EP2019/073684, filed Sep. 5, 2019, which claims priority to Japanese Patent Application No. 2018-175922, filed Sep. 20, 2018, the entire contents of which are incorporated herein by reference.

### BACKGROUND

The present invention relates to a gas storage material.

Gas storage is generally carried out by compressing or liquefying gases. With regard to a number of drawbacks in such cases, the importance has been emphasized of pressure-regulating devices and double steel cylinders capable of safely holding pressurized gases. In view of the high pressures required to obtain a satisfactory volume and safety problems inherent therein, cylinder shapes and sizes are generally fixed, and cannot easily be adjusted for specific applications. Such limitations relate to all commercial gases that require high pressures in order to be used in such applications and to gases and gas mixtures which cannot be safely compressed at such pressures and which require specialist containers.

Acetylene (C₂H₂) is a highly reactive gas which may explode when pressurized to 0.2 MPa or more even if oxygen is not present. This is due to C₂H₂ undergoing exothermic decomposition into C and H₂ and self-cyclization reactions. As a result, acetylene is a gas that cannot be stored at high pressure.

With the exception of high grade acetylene that is stored in a vapor phase at a pressure of less than 0.15 MPa (which leads to a low volume), practical methods for storing acetylene generally involve dissolving a gas (at a pressure of approximately 1.5 MPa) in an organic solvent (acetylene or N,N-dimethylformamide) contained in a steel cylinder filled with porous calcium silica and glass fibers. Moreover, the main application for this type of acetylene storage is welding and cutting (see Patent Document 1). The presence of solvents leads to high costs for manufacturers, handling becoming time-consuming and, in the case of inappropriate handling, serious safety risks for end users. Furthermore, for safety reasons, it is essential to avoid problems relating to solvents during use by limiting such applications, such as limiting flow rates, which correlate directly with cylinder dimensions, and limiting use of cylinders to use in upright positions. In cases where acetylene gas flows, solvent contamination is generally approximately 2-5%. As a result of the dependence of cylinder dimensions on flow rates, low volume cylinders may only have limited flow rates.

The presence of solvents leads to several problems. As mentioned above, solvent evaporation caused by desorption of acetylene (when a cylinder is used) leads to serious safety risks for users. In fact, solvent evaporation can lead to the formation of pockets that do not contain a solvent in a (dried) porous substance. Under such circumstances, because the initial storage pressure of acetylene is approximately 1.5 MPa, desorbed acetylene can form bubbles having a higher pressure than the explosion limit (0.2 MPa), which leads to the possibility of spontaneous explosion. In order to limit solvent evaporation and subsequent risk of explosion, the flow rate of a cylinder during use is limited by a direct relationship with the internal volume of the cylinder. Furthermore, degassing of acetylene from a solvent is an endothermic process that leads to subsequent cooling of a cylinder. Desorption of acetylene and, as a result, flow rate decrease, the cylinder is clearly exhausted until the temperature increases (to room temperature), and continuous use of the cylinder is seriously restricted.

In view of the problems mentioned above, which mainly relate to storage involving use of solvents, there is a pressing need to propose measures by which a satisfactory volume of acetylene can be stored without the use of solvents. Unlike solvent-based techniques, other commercially available acetylene containers are suitable for acetylene compressed at a pressure of 0.15 MPa. Such containers have high purity (no solvent contamination), but have lower storage volumes than containers involving use of solvents.

### CITATION LIST

### Patent Literature

Patent Document 1: Specification of U.S. Pat. No. 7,807,259

Adsorbents that exhibit conventional adsorption behaviour (have an IUPAC I type isothermal adsorption profile) have extremely low working pressure ranges, that is, the container pressure is preferably less than 0.2 MPa, and the release pressure is 0.1 MPa higher than the pressure at the container outlet, and this type of system has almost no benefit. As a result, there is very pressing need for storage measures capable of storing and releasing sufficient volumes of acetylene at low pressure in an adjustable manner. Similarly, measures for storing sufficient volumes of gases at low pressure (less than 3 MPa), whereby safety risks caused by such low pressures are further mitigated, are needed for all gases and gas mixtures.

Metal-Organic Frameworks (MOF), which are also known as Porous Coordination Polymers (PCP), are a type of organic-inorganic hybrid material comprising metal ion-based nodes that form a framework by means of coordination bonds with a variety of organic or organometallic ligands. These materials are porous and have high volumes and specific surface areas, and have attracted increased interest in the past few years in the scientific community. In addition, MOFs are highly adjustable and can give different materials if different organic ligands are used. In addition, MOFs have unique “respiration” or “flexible” structures, and therefore exhibit unique adsorption-desorption characteristics, and are mainly characterized by strong adsorption initiated by a gate opening pressure (storage pressure) that is related to adsorption/desorption hysteresis. In storage applications, this characteristic leads to a strong, rapid increase or decrease in adsorption amount within a small pressure range, and is therefore of great importance, and this means that these materials can achieve a higher working volume than materials that exhibit a conventional Langmuir adsorption isotherm profile.

However, even though this specific adsorption profile is an important matter of concern, flexible MOFs have hardly been researched, and regulating adsorption profiles remains difficult.

### SUMMARY

In view of the problems mentioned above, the purpose of the present invention is to provide a gas storage material and gas separation system capable of regulating the storage pressure and release pressure of a gas.

As a result of diligent research, the inventors of the present invention found that the purpose mentioned above could be achieved by using the configuration described below, and thereby completed the present invention.

One embodiment of the present invention relates to gas storage material which has two cubic lattice-shaped organometallic complexes, wherein the organometallic complexes contain at least two types of metal atom and the two organometallic complexes form an interpenetrating structure in which one apex portion of a unit cell of one of the organometallic complexes is positioned in a space inside one unit cell of the other organometallic complex.

This gas storage material has cubic lattice-shaped organometallic complexes as basic structures, and therefore exhibits higher flexibility than zeolites and activated carbon. In addition, an interpenetrating structure is formed, such that cells of one of the organometallic complexes alternately fits into spaces inside cells of the other organometallic complex. A gas that is an adsorbate is taken into spaces in the interpenetrating structure (hereinafter referred to as “gas intake spaces”). Prior to gas adsorption (at atmospheric pressure), the two organometallic complexes are aligned in a flat folded type arrangement so as to be stabilized in terms of energy by n-r stacking between ligands (a diamond-shaped arrangement in which, if a unit cell is viewed from the side, a pair of opposing corners are relatively close to each other). In other words, gas intake spaces are at a minimum. However, when gas pressurization starts and the gas pressure increases to a level where the energy stabilization breaks down, cells of the two organometallic complexes rise up and start to separate from each other (a square or rectangular arrangement in which, if a unit cell is viewed from the side, the pair of opposing corners that were relatively close to each other separate from each other). The gas intake spaces begin to enlarge or expand. Furthermore, at the stage where the gas pressure increases and the size of the gas intake spaces becomes larger than the size of a gas molecule, intake of the gas into the gas intake spaces starts. The pressure at this point is the storage pressure. If gas pressurization continues, the change in size of the gas intake spaces reaches an upper limit and no more gas intake occurs. The change in intake amount from the start to the end of gas intake is sharp, and this series of events corresponds to gate opening behaviour. If the gas is subsequently depressurized, release of the gas from the gas intake spaces starts. However, because the structure of cells in the complexes is stabilized by a gas packing effect in the gas intake spaces, the amount of gas released decreases slowly until the gas pressure decreases to a certain value. If the gas depressurization continues and a pressure is reached at which stabilization due to the packing effect breaks down, the gas is released rapidly from the gas intake spaces. The pressure at this point is the release pressure. If the pressure of the gas further decreases, the state of the gas storage material theoretically returns to the state prior to gas intake. This series of events during the depressurization corresponds to gate release behaviour. Therefore, one characteristic of gate opening-release behaviour is the presence of a hysteresis type adsorption-desorption curve.

The relative positions of the two organometallic complexes (that is, the sizes of the gas intake spaces) can vary according to the sizes of the unit cells. Furthermore, the organometallic complexes contain at least two types of metal atom, and by altering the content ratio of these metal atoms, it is possible to control the flexibility (deformation properties) of the organometallic complexes. As a result, the structures of the organometallic complexes per se can exhibit distortion (for example, a quadrangular prism in which the relative positions of the top surface and bottom surface of a cubic shape are displaced in a parallel manner and bring about shear deformation), and it is possible to alter the size and shape of the gas intake spaces. In this gas storage material, by controlling deformation of the complexes per se, which is caused by the inter-cell distance (the distance between adjacent complexes), the cell size and the content of the different types of metal atom in the interpenetrating structure of the cubic lattice-shaped organometallic complexes, it is possible to regulate the storage pressure and release pressure and exhibit efficient gas storage performance.

FIG. 1 (a) shows a schematic explanatory diagram of an adsorption-desorption curve for conventional adsorption behaviour (an IUPAC I type isothermal adsorption profile) and FIG. 1 (b) shows a schematic explanatory diagram of a hysteresis type adsorption-desorption curve. In both the adsorption-desorption curve for conventional adsorption behaviour (an IUPAC I type isothermal adsorption profile) and the hysteresis type adsorption-desorption curve, the adsorption pressure (storage pressure: P2) is similar. However, when the gas pressure decreases from P2 to P1, gas desorption hardly occurs in the former curve, whereas almost all of the adsorbed gas is desorbed in the latter curve. Because the value obtained by subtracting the desorbed amount from the adsorbed amount corresponds to the working volume able to be used within the working pressure range, the gas storage material that exhibits hysteresis type adsorption-desorption behaviour can exhibit a high working volume at a working pressure range similar to that used in the past. Because the storage pressure and release pressure can be regulated in this gas storage material, it is possible to set a working volume, working pressure range and working temperature according to a target gas.

One embodiment may be such that in the organometallic complexes of the gas storage material,

if an apex portion of a unit cell is positioned at the centre of an orthogonal coordinate system comprising an x-axis, a y-axis and a z-axis,

2 metal atoms are present at the centre,

a planar lattice structure is formed such that four dicarboxylic acid ion ligands form a paddle wheel type unit in the x-axis direction and y-axis direction relative to the two metal atoms, and

two or four pyridine derivative ligands are coordinated as pillar ligands from the z-axis direction relative to the two metal atoms and a cubic lattice structure is formed in such a way that the planar lattice structure is layered in the z-axis direction.

In one embodiment, the dicarboxylic acid ion ligands are preferably represented by any of formulae (1a) to (1f) below:

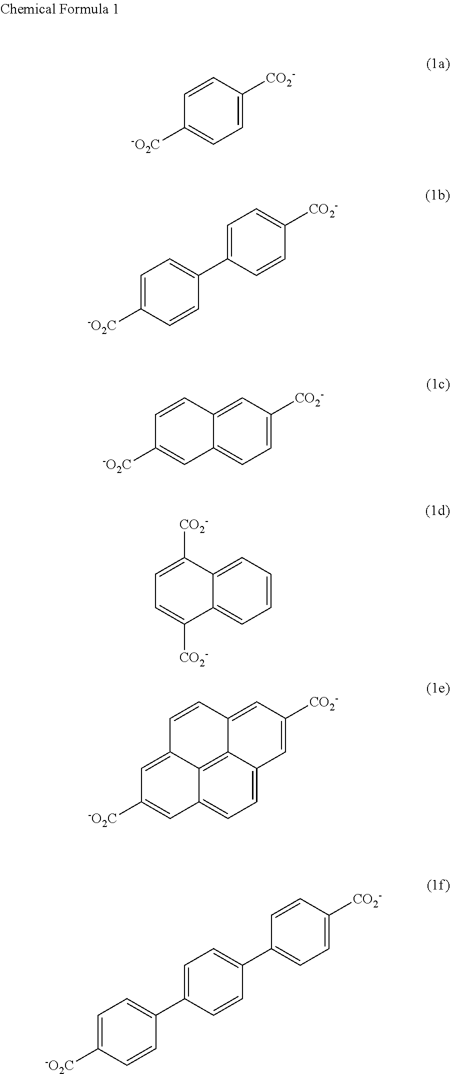

In one embodiment, the pyridine derivative ligands are preferably represented by any one of formulae (2a) to (2d) below.

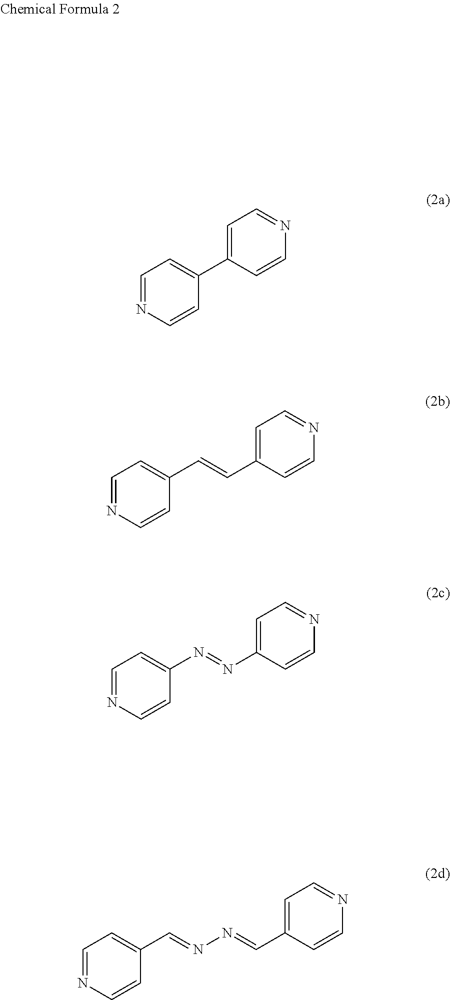 [SMILES: c1cc(-c2ccncc2)ccn1 ; C(=C\c1ccncc1)/c1ccncc1 ; c1cc(/N=N/c2ccncc2)ccn1 ; C(=N\N=C\c1ccncc1)/c1ccncc1]

The dicarboxylic acid ion ligands and pyridine derivative ligands represented by the formulae above are preferred from the perspectives of the size of the gas intake spaces (the size of the unit cells), affinity for the gas, ease of synthesis of the gas storage material, and ease of procurement of raw materials. By using these ligands, it is possible to regulate the storage pressure and release pressure according to the target gas and achieve efficient gas storage.

One embodiment preferably contains two metals selected from among Sc, Ti, V, Cr, Mn, Fe, Co, Ni, Cu and Zn as the metal atoms. Of these, Cu and Zn are preferred as the metal atoms. By using different types of metal, such as those mentioned above, as the metal atoms that constitute the organometallic complexes, cubic lattice-shaped organometallic complexes can be produced efficiently and simply, and gas storage pressure and release pressure can be controlled more easily.

In one embodiment, the gas storage material can be advantageously used to store a gas having an explosion limit of 0.2 MPa at 25° C. in a non-oxidizing atmosphere. Because the storage pressure and release pressure can be regulated according to a target gas, the gas storage material is suitable for storing gases that are difficult to handle at high pressures.

In one embodiment, the gas may be acetylene.

Another embodiment of the present invention is a gas storage system which stores one or more gases, and which comprises the gas storage material,

a pressurization and depressurization mechanism for increasing or decreasing the pressure of the gas(es), and

a control unit for controlling the pressure of the pressurization and depressurization mechanism, wherein

the storage pressure of the gas(es) into the gas storage material and the release pressure from the gas storage material are controlled by altering the content ratio of the metal atoms that form the organometallic complexes of the gas storage material.

In this gas storage system, the storage pressure and release pressure of the gas storage material can be regulated simply by altering the content ratios of the metals being used rather than carrying out alterations at the ligand design stage, and more efficient gas storage is therefore possible. In fact, it is possible to construct a gas storage system that is tailor-made for a target gas.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 (a) is a schematic explanatory diagram of an adsorption-desorption curve for conventional adsorption behaviour (an IUPAC I type isothermal adsorption profile) and FIG. 1 (b) is a schematic explanatory diagram of a hysteresis type adsorption-desorption curve.

FIG. 2 is a diagram that schematically illustrates a gas storage material according to one embodiment.

FIG. 3 is a schematic diagram that illustrates one example of a paddle wheel type organometallic node structure, as seen in an organometallic complex that forms the gas storage material.

FIG. 4 (a) to (c) are schematic diagrams that illustrate other examples of a paddle wheel type organometallic node structure, as seen in an organometallic complex that forms the gas storage material.

FIG. 5 shows acetylene adsorption-desorption curves, with (a) showing results for a case in which a Zn-CAT-A1 type organometallic complex ([Zn₂(bdc)₂(bpy)₂]ₙ) was used and (b) showing results for a case in which a Cu-CAT-A1 type organometallic complex ([Cu₂(bdc)₂(bpy)₂]ₙ) was used.

FIG. 6 shows analysis charts obtained from powder X-Ray diffraction (pXRD) of different gas storage materials, with (a) being a chart for CAT-A1 type organometallic complexes in which the Cu—Zn ratio was altered and (b) being a chart showing actual measurements and simulations for CAT-A2 type organometallic complexes in which the Cu—Zn ratio was altered.

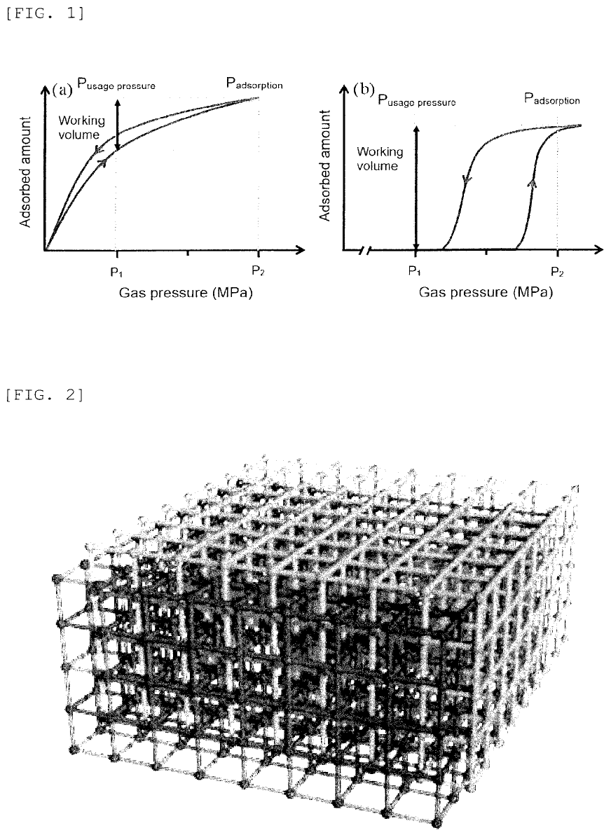

### DESCRIPTION OF THE PREFERRED EMBODIMENTS

Embodiments of the present invention will now be explained with reference to the drawings. The embodiments explained below explain one example of the present invention. The present invention is in no way limited to the embodiments given below, and encompasses a variety of modified forms able to be carried out without altering the gist of the present invention. Moreover, it is not necessarily true that all of the configurations explained below are essential configurations of the present invention. Moreover, in some or all of the drawings, parts that are not required for the explanations may be omitted, and in order to facilitate the explanations, parts may be enlarged or reduced in scale.

Gas Storage Material

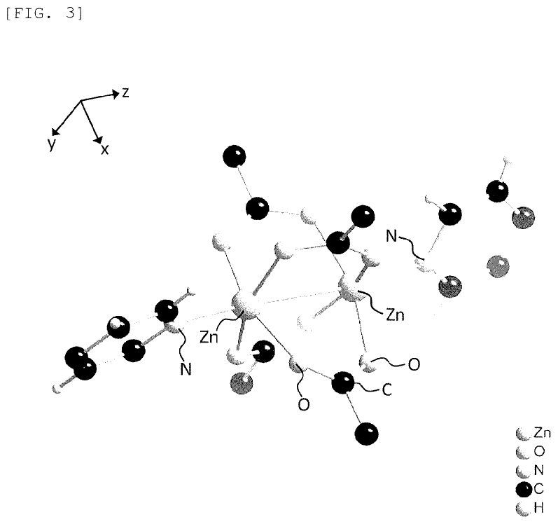

FIG. 2 is a diagram that schematically illustrates a gas storage material according to one embodiment. The gas storage material of the present embodiment has two cubic lattice-shaped organometallic complexes (a dark-coloured lattice and a light-coloured lattice), which correspond to so-called inter-accommodating organometallic frameworks (also known as a flexible MOF or gate opening MOF). Furthermore, the two organometallic complexes form an interpenetrating structure in which one apex portion of a unit cell of one of the organometallic complexes is positioned in a space inside one unit cell of the other organometallic complex. In other words, the gas storage material belongs to the MOF family, in which two elements are linked (CAT: Catenated MOF). A CAT is a structure in which two independent three-dimensional cubic lattice-shaped frameworks penetrate each other. Flexible frameworks may exhibit different types of flexibility.

In the gas storage material of the present embodiment, MOF phases develop as adsorption progresses, and it is possible to further increase the volume of gas intake spaces, which contributes to rapid gas storage by the interpenetrating structure. Therefore, almost no adsorbed gas remains under usage conditions, and a high working volume is achieved. The working volume of the gas storage material is preferably 75% v/v or more, and more preferably 90% v/v or more. The working pressure is preferably 3.5 MPa or less, and more preferably 0.1-1.0 MPa. The amount of residual gas to be stored in the gas storage material under usage conditions is negligible. The working temperature is preferably −40° C. to 150° C., and more preferably 10° C. to 30° C.

Moreover, explanations are made on the understanding that usage conditions are generally atmospheric conditions (typically, but not limited to, 0.1 MPa and 298 K). The storage amount is defined as the amount of gas stored by the gas storage material at a low temperature and/or a high pressure, and the residual amount corresponds to the amount of gas to be stored by the gas storage material at the usage temperature and pressure. The working volume corresponds to the difference between the charged amount of gas that has not been stored by the gas storage material and the amount remaining while being stored in the gas storage material. Therefore, the working volume corresponds to the total amount of gas able to be used (stored) per one unit of the gas storage material (1 storage-release cycle).

The independent organometallic complexes (frameworks) typically comprise metal centres (preferably transition metals), planar lattice-forming ligands alternately coordinated perpendicularly to the metal centres within a plane, and pillar ligands coordinated perpendicularly to the plane relative to the metal centres, thereby forming a cubic lattice-shaped structure.

The present embodiment may be such that in the organometallic complexes of the gas storage material, if an apex portion of a unit cell is positioned at the centre of an orthogonal coordinate system comprising an x-axis, a y-axis and a z-axis,

2 metal atoms are present at the centre,

a planar lattice structure is formed such that four dicarboxylic acid ion ligands form a paddle wheel type unit in the x-axis direction and y-axis direction relative to the two metal atoms, and

two or four pyridine derivative ligands are coordinated as pillar ligands from the z-axis direction relative to the two metal atoms, and a cubic lattice structure is formed in such a way that the planar lattice structure is layered in the z-axis direction.

In one embodiment, the dicarboxylic acid ion ligands are preferably represented by any of formulae (1a) to (1f) below:

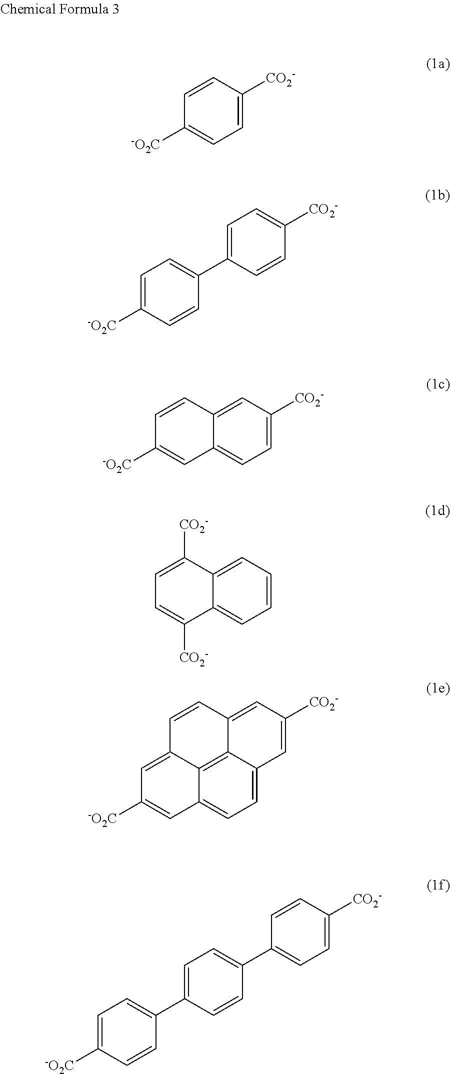

Of these, the dicarboxylic acid ion ligands are more preferably compounds represented by any of formulae (1a) to (1c) above.

In one embodiment, the pyridine derivative ligands are preferably represented by any one of formulae (2a) to (2d) below:

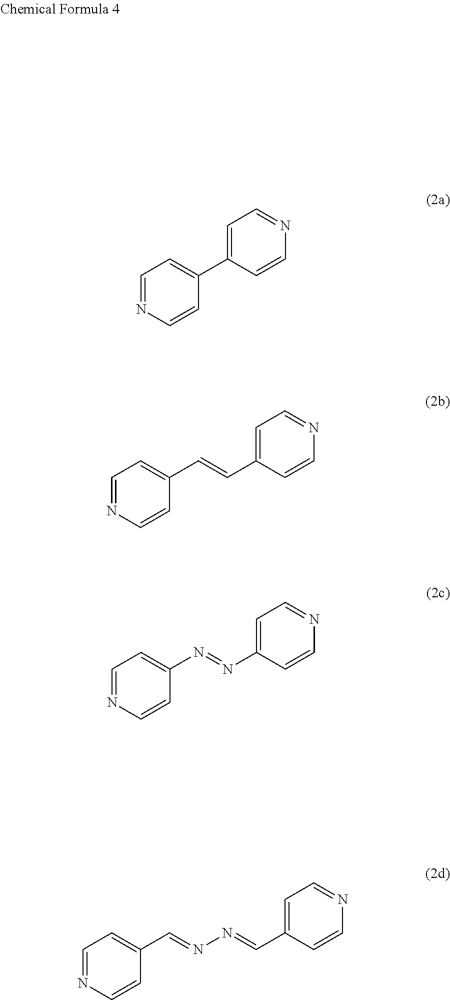 [SMILES: c1cc(-c2ccncc2)ccn1 ; C(=C\c1ccncc1)/c1ccncc1 ; c1cc(/N=N/c2ccncc2)ccn1 ; C(=N\N=C\c1ccncc1)/c1ccncc1]

The dicarboxylic acid ion ligands and pyridine derivative ligands represented by the formulae above are preferred from the perspectives of the size of the gas intake spaces (the size of the unit cells), affinity for the gas, ease of synthesis of the gas storage material and ease of procurement of raw materials. By using these ligands, it is possible to regulate the storage pressure and release pressure according to the target gas and achieve efficient gas storage.

In the gas storage material of the present embodiment, it is possible to control the storage pressure, the release pressure and the temperatures at which these occur by preparing organometallic complexes containing different types of metal while hardly altering the structures of the obtained organometallic complexes. The mode of adsorption hardly changes even if different types of metal are used as the metal atoms that form the organometallic complexes. Therefore, by preparing organometallic complexes containing different types of metal (hereinafter also referred to as “heterometallic complexes”), it is possible to control the storage pressure and release pressure (at fixed temperatures) without altering the working volume (adsorption amount) of the gas storage material. As the gate opening (storage) and gate closing (release) behaviour shifts, even if the overall working volume remains the same, the working volume can be highly regulated so as to conform to the target pressure and temperature ranges. In one embodiment, these different types of metal are preferably two metals selected from among Sc, Ti, V, Cr, Mn, Fe, Co, Ni, Cu and Zn. Of these, Cu and Zn are preferred as the metal atoms. In binary organometallic complexes obtained using Cu and Zn, as the amount of Cu increases, the gate opening pressure (storage pressure) tends to decrease.

By using metals such as those mentioned above as the metal atoms that form the organometallic complexes, cubic lattice-shaped organometallic complexes can be produced efficiently and simply, and gas storage pressure and release pressure can be controlled more easily.

Moreover, the manner in which the different metals are contained in the two organometallic complexes is not particularly limited, and in cases where, for example, a metal A and a metal B are contained, the following forms are possible: (a) one of the organometallic complexes contains only metal A and the other organometallic complex contains only metal B, (b) one of the organometallic complexes contains metal A and metal B and the other organometallic complex contains only metal A, (c) one of the organometallic complexes contains metal A and metal B and the other organometallic complex contains only metal B, and (d) both of the organometallic complexes contain both metal A and metal B. From the perspectives of ease of synthesis of the organometallic complexes and uniformity of characteristics of the two complexes, (d) is preferred.

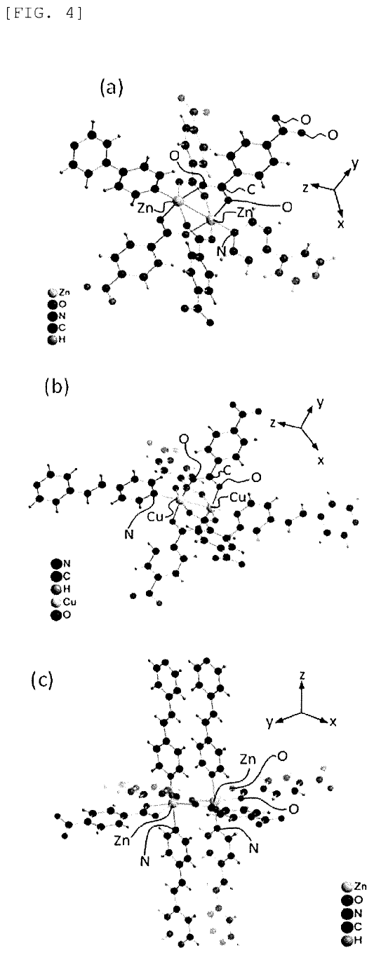

By combining the ligands and metal atoms mentioned above, it is possible to obtain geometric forms of organometallic complexes having a variety of forms (for example, metal-carboxylic acid ion paddle wheel forms). FIG. 3 is a schematic diagram that illustrates one example of a paddle wheel type organometallic node structure, as seen in an organometallic complex that forms the gas storage material. In a possible complex having a metal-metal bond (an MM bond), a plane is formed in which four carboxylic acid ion groups coordinate to two metal ions (Zn) from the x-axis direction and y-axis direction and oxygen (O) surrounds the metal ions. In addition, the z-axis direction is occupied by nitrogen (N) in two pyridine derivative ligands. In the present specification, this type of node structure is defined as a CAT-A type.

A specific example of a heterometallic complex is a structure CAT-A1, which is represented by the general formula [M₂(bdc)₂(bpy)]ₙ, is constituted from metals, benzenedicarboxylic acid (bdc) and 4,4′-bipyridine (bpy), and is obtained using at least zinc (II) and copper (II). In all cases, the metal atoms form a metal-carboxylic acid ion paddle wheel structure (see FIG. 2). Cu—Zn-based heterometallic complexes having a variety of Cu/Zn ratios were prepared by a mixed metal synthesis process comprising incorporating Cu while synthesizing a Zn-based organometallic complex. The Cu content and Cu/Zn ratio were controlled by altering the amounts of both types of metal atom introduced during this process.

Examples of types of interpenetrating structure in heterometallic complexes include (1) MOFs comprising two or more metals that separately form the same type of structure (node or framework), (2) MOFs constituted from two or more metals that form different structures having similar or different molecular formulae, and (3) MOFs comprising mixtures of three or more metals that form 2×2 similar structures and/or different structures. Metal ions can be incorporated as metal exchange by carrying out a publicly known synthesis and then modifying, or by one-pot mixed metal synthesis.

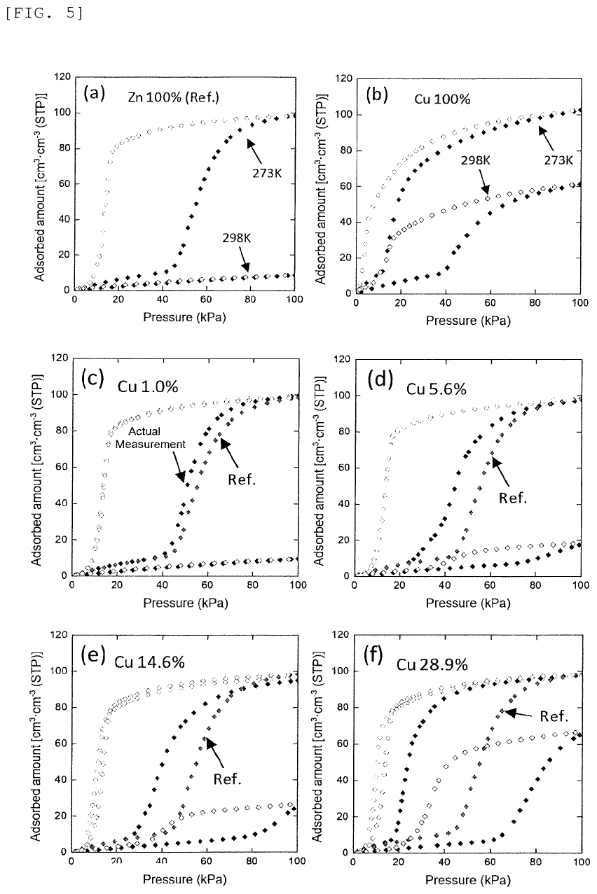

Further examples of heterometallic complexes are shown in FIG. 4. FIG. 4 shows schematic diagrams that illustrate other examples of a paddle wheel type organometallic node structure, as seen in an organometallic complex that forms the gas storage material. A structure represented by the general formula [M₂(bdc)₂(dpe)]ₙ is referred to as a CAT-A2 type structure, which comprises a metal (Cu), benzenedicarboxylic acid (bdc) and 1,2-dipyridylethylene (dpe) (see FIG. 3 (b)). In a case where Cu is used instead of Zu, Cu (II) forms a CAT-A2 type structure having a single paddle wheel type complex (similar to a CAT-A1 type structure in which Zn is used (see FIG. 3 (a))). In addition, Zn (II) forms a CAT-B2 type structure in which metal nodes are identical to the structure of a bis(columnar) bis(metal dicarboxylate) complex represented by the general formula [M₂(bdc)₂(dpe)₂]ₙ (see FIG. 3 (c)). A CAT-B2 type structure can be formed under similar conditions to a CAT-A type structure.

The gas storage material of the present embodiment can be advantageously used to store a gas having an explosion limit of 0.2 MPa at 25° C. in a non-oxidizing atmosphere. Because the storage pressure and release pressure can be regulated according to a target gas, the gas storage material is suitable for storing gases that are difficult to handle at high pressures. Acetylene can be given as an example of this type of explosive gas. In addition, gases other than explosive gases can be given as examples of gases to be stored, and gases such as oxygen, hydrocarbon gases having few carbon atoms (for example, four or fewer carbon atoms) other than acetylene, and inert gases such as noble gases and nitrogen can be advantageously stored.

The method for producing the gas storage material is not particularly limited, and a method that is well known as a MOF production method can be used. Specific examples thereof include one-pot synthesis methods (for example, self-assembly methods, solvothermal methods, microwave irradiation methods, ionothermal methods, high throughput methods, and the like), stepwise synthesis methods (for example, organometallic node structure precursor complex methods, complex ligand methods, in-situ sequential synthesis methods, synthesis-modification methods, and the like), sonochemical synthesis methods and mechanochemical synthesis methods.

In an example of a production method that uses a self-assembly method, which is a type of one-pot synthesis method, a metal salt (for example, a metal nitrate or the like) that provides a metal centre and a planar lattice-forming ligand that provides a planar lattice structure are mixed in a solvent. A gas storage material in which cubic lattice-shaped organometallic complexes penetrate each other can be formed by adding a mixture containing a pillar ligand and a solvent to a mixture containing complexes having planar lattice structures, and allowing these mixtures to react either at room temperature or under heating.

The solvent for dissolving the ligands and metal salt is not particularly limited, and it is possible to use a cyclic or non-cyclic amide-based solvent such as dimethylformamide (DMF) or N-methylpyrrolidone, an alcohol-based solvent such as methanol or ethanol, a ketone-based solvent such as acetone, an aromatic solvent such as toluene, water, or the like. The reaction temperature is preferably 25-150° C., and more preferably 70-120° C. The reaction time is preferably 2-72 hours, and more preferably 6-48 hours. The target gas storage material can be produced by collecting the product of the reaction by means of filtration, centrifugal separation, or the like, and, if necessary, washing with a solvent mentioned above and then drying.

One embodiment of the present invention relates to a gas storage system which stores one or more gases, and which comprises the gas storage material, a pressurization and depressurization mechanism for increasing or decreasing the pressure of the gas(es), and a control unit for controlling the pressure of the pressurization and depressurization mechanism, wherein by altering the content ratio of the metal atoms that form the organometallic complexes of the gas storage material the storage pressure of the gas into the gas storage material and the release pressure from the gas storage material are controlled.

Publicly known features can be used as the pressurization and depressurization mechanism and the control unit, which are not shown, and these are operated in combination to control the gas pressure. A pressurization pump, depressurization (vacuum) pump, or the like, can be used as the pressurization and depressurization mechanism. The control unit preferably controls temperature, flow rate, and the like, in addition to the pressure of the mixed gas. A publicly known computing device, such as a CPU or MPU, can be used as the control unit.

In the gas storage system of the present embodiment, the storage pressure and release pressure of the gas storage material can be regulated simply by altering the content ratios of the metals being used rather than carrying out alterations at the ligand design stage, and more efficient gas storage is therefore possible. In fact, it is possible to construct a gas storage system that is tailor-made for a target gas.

In the gas storage material and gas storage system explained hitherto, a gas is stored in a solid adsorbent (storage material). Therefore, the present invention enables a container to be handled safely regardless of the orientation thereof, unlike cases where storage in a liquid form or dissolution in a solvent occurs. The absence of a solvent allows the objective of higher gas purity to be achieved.

### WORKING EXAMPLES

The present invention will now be explained in greater detail through the use of working examples, but the present invention is not limited to the working examples given below as long as the gist of the present invention is not exceeded.

All the chemical substances and solvents were purchased as commercial quality products and used without being refined. Moreover, abbreviations of components used in the working examples are as follows:

bdc: 1,4-biphenyldicarboxylic acid

bpy: 4,4′-bipyridine

dpe: 1,2-(dipyridyl)ethylene

DMF: dimethylformamide

### Synthesis of Gas Storage Material

### Synthesis Example 1: Synthesis of Cu—Zn-CAT-A1

A heterometallic complex was produced under the same conditions as those used for Zn-CAT-A1. The desired final metal ratio was controlled during synthesis by using a good fit between the synthesis Cu:Zn input ratio and the input ratio observed in the material following synthesis. A complex in which the content ratio of Cu was 25% relative to the total metal quantity was synthesized using the following procedure. First, bdc (2 equivalents) dissolved in the minimum quantity of DMF was added to an ethanol-DMF (50:50) solution containing zinc (II) nitrate (1.5 equivalents) and copper (II) nitrate (0.5 equivalents) (Cu/[Zn+Cu]=25%). Next, the mixture was placed in a constant temperature oil bath set to a temperature of 100° C. (the temperature was controlled using the constant temperature oil bath), and a solution of bpy (1 equivalent) in ethanol-DMF was added to the mixture dropwise. The solvent mixture was ethanol DMF at a volume ratio of 50:50 overall, and after adding the bpy, the reactants were stirred at a temperature of 100° C. (the temperature was controlled using the constant temperature oil bath). After reacting for 24-48 hours, the reaction mixture was cooled to room temperature, and a precipitate was recovered by means of centrifugal separation and then washed three times with DMF and three times with ethanol so as to remove unreacted species. This powder was dried for several hours under reduced pressure, thereby producing a gas storage material having Cu—Zn-CAT-A1 organometallic complexes. The yield was approximately 44%.

### Synthesis Example 2: Synthesis of Zn—Cu-CAT-A1

A heterometallic complex was produced under the same conditions as those used for Zn-CAT-A1. The desired final metal ratio was controlled during synthesis by using a good fit between the synthesis Zn:Cu input ratio and the input ratio observed in the material following synthesis. A complex in which the content ratio of Zn was 20% relative to the total metal quantity was synthesized using the following procedure. bdc (2 equivalents) dissolved in the minimum quantity of DMF was added to a solution of copper (II) nitrate (1.6 equivalents) and zinc (II) nitrate (0.4 equivalents) (Zn/[Zn+Cu]=20%). Next, a solution of bpy (1 equivalent, 2 mmol) in DMF was added dropwise to the mixture, which had been placed on an oil bath set to a temperature of 120° C. The total quantity of solvent was 250 ml. Following the addition, the reactants were stirred at 120° C. (the temperature was controlled using the constant temperature oil bath). After reacting for 24-48 hours, the reaction mixture was cooled to room temperature, and a precipitate was recovered by means of centrifugal separation and then washed three times with DMF and three times with ethanol so as to remove unreacted species. This powder was dried for several hours under reduced pressure, thereby producing a gas storage material having Zn—Cu-CAT-A1 organometallic complexes. The yield was approximately 89%.

### Synthesis Example 3: Synthesis of Zn—Cu-CAT-A2

Heterometallic complexes were produced under the same conditions as those used for Cu-CAT-A2. The desired final metal ratio was controlled during synthesis by using a good fit between the synthesis Zn:Cu input ratio and the input ratio observed in the material following synthesis. A complex in which the content ratio of Zn was 20% relative to the total metal quantity was synthesized using the following procedure. bdc (2 equivalents) and dpe (1 equivalent) were dissolved in 40 ml of DMF placed in a 100 ml Teflon® chamber. Next, a solution of zinc (II) nitrate (1.75 equivalents) and copper (II) nitrate (0.25 equivalents) in 20 ml of DMF (Zn/[Zn+Cu]=12.5%) was added under stirring to the bpy/bdc mixture. The Teflon® chamber was placed in a sealed stainless steel autoclave placed in an oven programmed to a temperature of 120° C. for 40 hours. After 40 hours, the container was cooled to close to room temperature, after which a crystalline precipitate was recovered and washed three times with DMF and three times with methanol so as to remove unreacted species. This powder was dried for several hours under reduced pressure, thereby producing a gas storage material having Zn—Cu-CAT-A2 organometallic complexes. The yield was approximately 80%.

### Reference Synthesis Example 1

Synthesis of Zn-CAT-A1 bdc (2 equivalents, 85 mmol) was dissolved in the minimum quantity of DMF and added to an ethanol-DMF (50:50) solution of zinc (II) nitrate (2 equivalents, 85 mmol). The mixture was heated using a constant temperature oil bath set to a temperature of 100° C. Next, a solution of bpy (1 equivalent, 42.5 mmol) in ethanol-DMF was added dropwise to the mixture. The total volume of solvent was 900 ml, and the composition of the solvent was ethanol (50 vol %) and DMF (50 vol %). Following the addition (approximately 20 minutes to 1 hour after the addition), the reactants were stirred at 100° C. (the temperature was controlled using the constant temperature oil bath). After reacting for 24-48 hours, the reaction mixture was cooled to room temperature, and a precipitate was recovered by means of centrifugal separation and then washed three times with DMF and three times with ethanol so as to remove unreacted species. This powder was dried for several hours under reduced pressure, thereby producing a gas storage material having Zn-CAT-A1 organometallic complexes. The yield was approximately 98%.

### Reference Synthesis Example 2

Synthesis of Cu-CAT-A1 bdc (2 equivalents) and bpy (1 equivalent) were dissolved in 40 ml of DMF placed in a 100 ml Teflon® chamber. Next, a solution of copper (II) nitrate (2 equivalents, 2 mmol) in 20 ml in DMF was added dropwise to the bpy/bdc mixture. The Teflon® chamber was placed in a sealed stainless steel autoclave placed in an oven programmed to a temperature of 120° C. for 24 hours. After 24 hours, the container was cooled to close to room temperature, after which a crystalline precipitate was recovered and washed three times with DMF and twice with methanol so as to remove unreacted species. This powder was dried for several hours under reduced pressure, thereby producing a gas storage material having Cu-CAT-A1 organometallic complexes. The yield was approximately 83%.

### Reference Synthesis Example 3

Synthesis of Zn-CAT-B1 Zinc nitrate (1 equivalent, 1 mmol) dissolved in 20 ml of DMF, dpe (1 equivalent, 1 mmol) dissolved in 20 ml of DMF and bdc (1 equivalent, 1 mmol) dissolved in 20 ml of DMF were mixed together. This mixture was heated using a constant temperature oil bath set to a temperature of 100° C. (the temperature was controlled using the constant temperature oil bath) and stirred at this temperature. After 18 hours, the container was cooled to close to room temperature, after which a crystalline precipitate was recovered and washed three times with DMF and twice with methanol so as to remove unreacted species. This powder was dried for several hours under reduced pressure, thereby producing a gas storage material having Zn-CAT-B1 organometallic complexes. The yield was approximately 90%.

### Reference Synthesis Example 4

Synthesis of Cu-CAT-A2 bdc (2 equivalents) and dpe (1 equivalent) were dissolved in 40 ml of DMF placed in a 100 ml Teflon® chamber. Next, a solution of copper (II) nitrate (2 equivalents, 2 mmol) in 20 ml in DMF was added dropwise to the bpy/bdc mixture. The Teflon® chamber was placed in a sealed stainless steel autoclave placed in an oven programmed to a temperature of 120° C. for 24 hours. After 24 hours, the container was cooled to close to room temperature, after which a crystalline precipitate was recovered and washed three times with DMF and twice with methanol so as to remove unreacted species. This powder was dried for several hours under reduced pressure, thereby producing a gas storage material having Cu-CAT-A2 organometallic complexes. The yield was approximately 83%.

### Reference Synthesis Example 5

### Synthesis of Zn-CAT-B1 Single Crystal

A Zn-CAT-B1 single crystal was produced using a layering method. Zinc (II) nitrate, dpe and bpy were first solubilized in DMF at a concentration of approximately 75 mmol·L⁻¹. In a 1 mL vial, layers of zinc (II) in DMF (100 μl), a DMF solvent (750 μl), bdc in DMF (100 μl) and dpe in DMF (50 μl) were carefully formed. The vial was placed in a static bath at 100° C. and heated for several days. A crystal was obtained, and then held in a base liquor before being analyzed by means of single crystal X-Ray diffraction.

Evaluations

All of the materials were characterized by means of powder X-Ray diffraction (pXRD), thermogravimetric analysis (TGA), CO₂ gas adsorption at 195 K, C₂H₂ adsorption at 195 K, 273 K and 298 K, and energy dispersive X-Ray analysis (SEM-EDX). Particle size and particle size distribution were measured using Image J software provided by the National Institutes of Health (USA), using a minimum of 100 particles in order to determine the average particle diameter. The metal ratio in a particle was determined using energy dispersive X-Ray analysis (EDX) comprising X-Ray fluorescence (XRF) and SEM-EDX. Element mapping was carried out using SEM-EDX, and it was confirmed that metal elements were uniformly distributed in the particles. Metal ratio analysis was carried out using a single metal compound. All the results were consistent with theoretical expectations (pXRD/gas adsorption) and published results. Single crystal structures were analyzed using X-Ray diffraction measurements.

Thermogravimetric Analysis (TGA)

TGA was carried out in a nitrogen flow using a Rigaku TG8120. Approximately 5-10 mg of a sample was heated from 25° C. to 500° C. at a temperature increase rate of 5° C./min in a nitrogen gas stream.

Powder X-Ray Diffraction (pXRD)

pXRD was carried out with a Rigaku SmartLab X-Ray diffraction apparatus (40 kV, 40 mA) using CuKα radiation. pXRD data was recorded at a scanning speed of 5°/min and at steps of 0.01° from 3° to 60° (20).

XRF Measurements

XRF measurements were carried out using a Rigaku EDXL300 spectrometer.

SEM-EDX Measurements

Scanning electron microscope-energy dispersive X-Ray (SEM-EDX) measurements were carried out using an EDAX EDS fitted to a Hitachi SU5000 FE-SEM operating at an accelerating voltage of 30 kV. FE-SEM images were taken using a Hitachi SU5000 FE-SEM system operating at an accelerating voltage of 15 kV. A sample was placed on an electrically conductive carbon tape on a SEM sample holder, and then covered with osmium.

Adsorption Characteristics

Isothermal gas adsorption was carried out using volume adsorption apparatuses (BELsorp-MAX and BELsorp-mini-II) (BEL Japan, Inc.) provided with a cryostat for controlling temperature (BELsorp-MAX) and a small cold constant temperature bath or Dewar tank (BELsorp-mini-II). All the samples were stripped of guest molecules (solvent) by being degassed under vacuum for at least 6 hours at 423 K prior to adsorption measurements.

Results

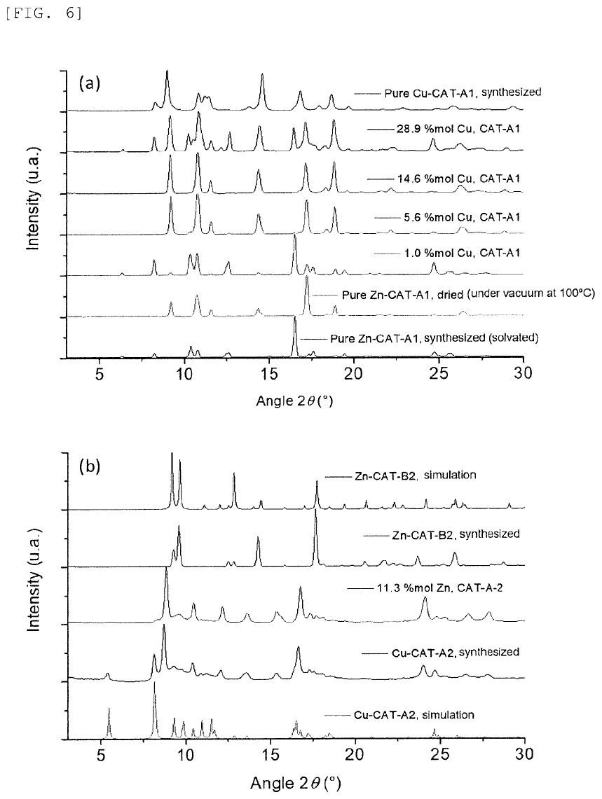

FIG. 5 shows acetylene isothermal adsorption-desorption curves. FIG. 5 (a) shows results for a case in which a Zn-CAT-A1 type organometallic complex ([Zn₂(bdc)₂(bpy)₂]ₙ) was used and FIG. 5 (b) shows results for a case in which a Cu-CAT-A1 type organometallic complex ([Cu₂(bdc)₂(bpy)₂]ₙ) was used. FIGS. 5 (c), (d), (e) and (f) show results for Cu—Zn heterometallic complexes containing 1.0 mol % of Cu, 5.6 mol % of Cu, 14.6 mol % of Cu and 28.9 mol % of Cu, respectively. In FIG. 5, solid diamond shapes indicate adsorption and hollow diamond shapes indicate desorption, and results are shown for measurements at 273 K and 298 K. In FIG. 5 (c) to (f), results are also shown for a Zn-CAT-A1 type organometallic complex as a reference. Density was calculated on the basis of single metal MOF crystal density.

TABLE 1

| | | Intermediate | |
|---|---|---|---|
| | Gate opening | adsorption | Estimated |
| Cu Content | pressure (P_{go}) | pressure (P_{half}) | working volume |
| [% mol] | [kPa] | [kP] | [v/v] |
| 0.0 | 45 | 56 | 89.8 |
| 1.0 | 43 | 52 | 89.9 |
| 5.6 | 37 | 45 | 79.8 |
| 14.6 | 27 | 40 | 70.9 |
| 28.9 | 18 | 25 | 31.0 |
| 100.0 | 12 | 19 | 17.0 |

Top row (left to right):

Cu content [mol %]

Gate opening pressure (P_{go}) (storage pressure) [kPa]

Intermediate adsorption pressure (P_{half}) [kPa]

Estimated working volume [v/v]

As shown in FIG. 5 and Table 1, it is understood that variations in gate opening pressure at 273 K relate to the amount of Cu incorporating in the structure. Due to symmetry, the gate closing pressure (release pressure) at 298 K also relates to the metal ion composition in the heterometallic complex. As a result, the gas storage material is such that the working volume under prescribed conditions can be regulated, as shown in the last column in Table 1. The apparent increase in working volume when the amount of Cu changes from 28.9 mol % to 100 mol % can be explained by a slight change in crystal density between the Zn-CAT-A1 type organometallic complex and the Cu-CAT-A1 type organometallic complex.

In additional evaluations shown in Table 2 (SEM), because no significant difference was seen when the Zn-CAT-A1 type organometallic complex was compared with the Cu—Zn-CAT-A1 heterometallic complex, it was possible to verify that there was no correlation with other parameters such as average particle diameter.

TABLE 2

| | Average | |
|---|---|---|
| | particle | Gate opening |
| Cu content | diameter | pressure (P_{go}) |
| [% mol] | [μm] | [kPa] |
| 0.0 | 10.0 ± 2.7 | 45 |
| 1.0 | 8.9 ± 2.9 | 43 |
| 5.6 | 7.9 ± 2.5 | 37 |
| 14.6 | 5.8 ± 2.1 | 27 |
| 28.9 | 6.9 ± 2.1 | 18 |
| 100.0 | 8.3 ± 3.5 | 12 |

Top row (left to right):

Cu content [mol %]

Average particle diameter [μm]

Gate opening pressure (P_{go}) [kPa]

FIG. 6 shows analysis charts obtained from powder X-Ray diffraction (pXRD) measurements for different gas storage materials. FIG. 6 (a) is a chart for CAT-A1 type organometallic complexes in which the Cu—Zn ratio was altered and FIG. 6 (b) is a chart of actual measurements and simulations for CAT-A2 type organometallic complexes in which the Cu—Zn ratio was altered. Incorporation of Zn (II) into the Cu-CAT-A2 structure was verified by XRF (showing 11.3 mol % of Zn) and powder X-Ray diffraction (pXRD). pXRD confirmed that a Cu-CAT-A2 phase was present and that a Zn-CAT-B2 phase was not observed even when a gas storage material was obtained under similar conditions. No Zn-CAT-B2 diffraction peak was present and a good match between diffraction peaks for the Cu-CAT-A2 structure and the Cu—Zn-CAT-A2 structure showed that material phases were bound by the primary metal (Cu).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-9. (canceled)

10. A gas storage material which has two cubic lattice-shaped organometallic complexes, comprising
organometallic complexes comprising at least two types of metal atom, wherein the two organometallic complexes form an interpenetrating structure in which one apex portion of a unit cell of one of the organometallic complexes is positioned in a space inside one unit-cell of the other organometallic complex.

11. The gas storage material according to claim 10, wherein in each of the organometallic complexes,
if an apex portion of a unit cell is positioned at the center of an orthogonal coordinate system comprising an x-axis, a y-axis and a z-axis,
and if 2 metal atoms are present at the center,
then a planar lattice structure is formed such that four dicarboxylic acid ion ligands form a paddle wheel type unit in the x-axis direction and y-axis direction relative to the two metal atoms, and
two or four pyridine derivative ligands are coordinated as pillar ligands from the z-axis direction relative to the two metal atoms and a cubic lattice structure is formed in such a way that the planar lattice structure is layered in the z-axis direction.

12. The gas storage material according to claim 11, wherein the dicarboxylic acid ion ligands are represented by any of formulae (1a) to (1f) below:
Chemical Formula 1

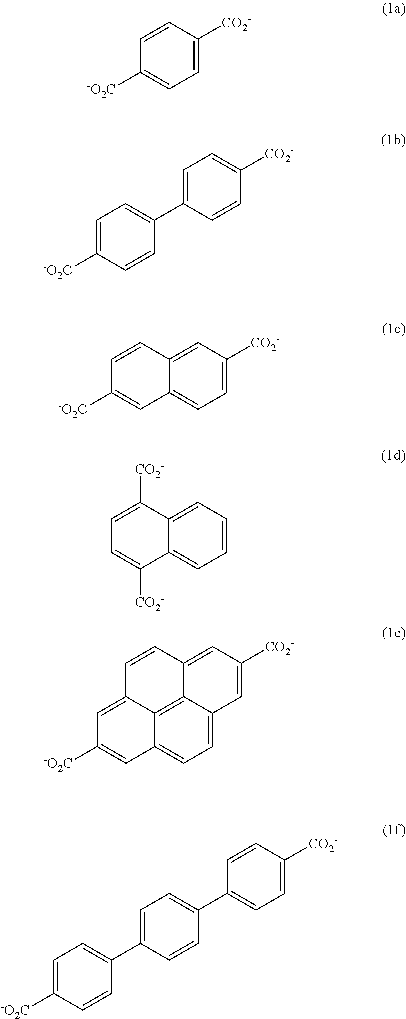

13. The gas storage material according to claim 11, wherein the pyridine derivative ligands are represented by any of formulae (2a) to (2d) below:

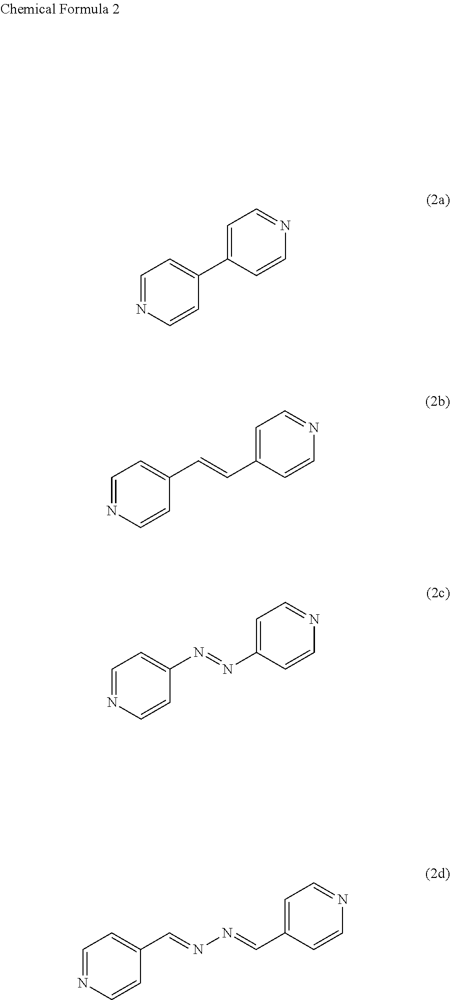 [SMILES: c1cc(-c2ccncc2)ccn1 ; C(=C\c1ccncc1)/c1ccncc1 ; c1cc(/N=N/c2ccncc2)ccn1 ; C(=N\N=C\c1ccncc1)/c1ccncc1]

14. The gas storage material according to claim 10, further comprising two metals selected from the group consisting of Sc, Ti, V, Cr, Mn, Fe, Co, Ni, Cu and Zn as the metal atoms.

15. The gas storage material according to claim 14, wherein the metal atoms are Cu and Zn.

16. A storage container comprising the gas storage material according to claim 10, wherein a gas is stored having an explosion limit of 0.2 MPa at 25° C. in a non-oxidizing atmosphere.

17. The storage container according to claim 16, wherein the gas is acetylene.

18. A gas storage system which stores one or more gases, and which comprises
the gas storage material according to claim 10,
a pressurization and depressurization mechanism for increasing or decreasing the pressure of the gas(es), and
a control unit for controlling the pressure of the pressurization and depressurization mechanism, wherein
the storage pressure of the gas(es) into the gas storage material and the release pressure from the gas storage material are controlled by altering the content ratio of the metal atoms that form the organometallic complexes of the gas storage material.
